(19) United States
(12) Patent Application Publication
(10) Pub. No.: US 2004/0002902 A1
(43) Pub. Date: Jan. 1, 2004

(54) System and method for the wireless access of computer-based services in an attributable manner

(76) Inventor: Max Muehlhaeuser, Ober-Ramstadt (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/376,342

(22) Filed: Mar. 3, 2003

Related U.S. Application Data
(63) Continuation of application No. PCT/EP01/09915, filed on Aug. 29, 2001.
(60) Provisional application No. 60/230,156, filed on Sep. 1, 2000.

(51) Int. Cl. G06F 17/60

(52) U.S. Cl. 705/26

(57) ABSTRACT

The invention relates to a method for the wireless access of computer-based services in an attributable manner, using a mobile hand-held device, by a service user who is temporarily in the vicinity of a local service computer, on which service software comprising an input for services and preferably an output for services is run. Said service software can be distributed among additional service computers. To access said services, the services user uses a personal, mobile hand-held device, which comprises a standard input/output and preferably a simulation system for the interactive entry of service data. The mobile handheld device for accessing a service interacts with the service software is a distributed service access and a wireless connection. The mobile hand-held device and the service computer transmit data, whose attributability is to be guaranteed, by means of digital signatures, according to an agreed protocol. Said data can be summarized in certificates and transaction data records and can be obtained in part on the mobile hand-held device, using read devices.

### CROSS-REFERENCE TO RELATED APPLICATIONS

This application is a continuation under 35 U.S.C. 120 of International Application PCT/EP01/09915, with an international filing date of Aug. 29, 2001, published as WO 02/19648 A2. This application and the International Application claim priority to U.S. Provisional Application No. 60/230,156, filed on Sep. 1, 2000.

### TECHNICAL FIELD

The invention relates to a system and method for wireless, attributable access to computer-based services, by means of a mobile hand-held device, by a service user.

### BACKGROUND

The expressions “mobile commerce” and “mobile electronic commerce” are commonly used to describe any type of electronic commerce that is not triggered or performed from the desk of a user, i.e., from the user's home or work place. In the case of mobile electronic commerce, it is assumed that the consumer is traveling, and that the seller's software can run on virtually any computer or computer network.

A method for implementing non-cash payments, which is applied in practice under the name “paybox,” is known from document DE 19903822 A1. Under this method, a payment is made by means of a mobile telephone. The process is based on the following model. The service user must register with a “paybox service” and authorize the paybox service to complete money transfers from his account. An authorization PIN, which is assigned to the mobile telephone number of the service user, is set up in a secure manner by the service user and the paybox service. When concluding a contract with a seller and/or provider, the service user is asked by the service software to enter his mobile telephone number into the seller's service computer. The service software then establishes a secure connection to the paybox service and transmits the amount to be paid, the account information for the provider of the service, and the mobile telephone number of the service user's mobile telephone entered by the service user. The paybox service then calls the service user, transmits data on the amount to be paid and the provider of the service, and asks the service user to confirm the funds transfer from his account to the account of the provider by entering his PIN.

This known method has various disadvantages. It is only suitable for processing payments made by a buyer to a seller, the mobile telephone number of the buyer must be provided to the seller, a third party, the paybox service, must be involved in the transaction, and the transaction requires the time-consuming and costly establishment of a wireless connection between the seller and the paybox service. In particular, the buyer cannot scroll through a range of products or services using his mobile telephone.

Document WO 97/05729 discloses a mobile wireless terminal that features an additional chip card reader with which prepaid chip cards can be used to pay the fees for use of the mobile wireless service. This device is only suitable for the collection of fees by the mobile wireless network provider, and features no general functionality for conducting mobile electronic commerce.

Document DE 19747603 A1 discloses a method for the digital signaling of a message by means of a mobile hand-held device, preferably a mobile telephone. In this process, the mobile hand-held device assumes the function of an autographing device, which is not connected through a local wired connection as, for example, is common in automated teller machines, but rather wirelessly through a telephone network, such as a mobile wireless network, to autograph an Internet banking procedure, for example. Spatial proximity between the mobile hand-held device and the information source and/or the recipient of the autographed message is not necessary. However, the known method is not suitable for autographing and does not permit interactive access to a service by means of the mobile hand-held device or a touch-free, wireless connection to a service computer, which offers a service in spatial proximity to a service user.

Document U.S. Pat. No. 6,038,549 discloses a method for encoded data transfer between a sender and a recipient, especially a pager, with which messages can be authenticated and verified. This method also does not permit interactive access to a service by means of a mobile hand-held device through a touch-free, wireless connection to a service computer, which offers a service in spatial proximity to a service user.

### SUMMARY

The invention is generally directed toward applications of computers and computer networks and, more specifically, toward techniques for providing users with wireless, attributable access to functions offered or brought about by means of computers, or so-called service functions. The invention is also closely related to mobile electronic commerce.

Mobile electronic commerce is a significant and important scope of application of the present invention. However, it is also directed toward other applications, so that the term “service user” is generally used instead of “consumer” and “service” instead of “product or service offered by the provider.” A service, as the term is used in the invention, is generally something that is offered by means of computer software and/or firmware, and establishes a relationship between the user and the service provider, which represents a contract in the legal sense, i.e., consists of an offer and the acceptance of said offer. The aforementioned software and/or firmware is referred to as service software in the context of the invention. “User,” in this context, refers to the user of the service software, hereinafter referred to as service user, while service provider is the person or party who provides the service, which is represented in the service software or is brought about by the service software.

In the context pertaining to the invention, a service user is more precisely understood to be a person who is traveling and is a potential candidate for accepting the service offered. This person is temporarily in proximity to the computer on which the service software is running and/or is offered. The service user takes along a mobile hand-held device, such as a mobile telephone or a pocket computer, which is permanently owned by said service user or is temporarily clearly personalized, i.e., unquestionably reflects the identity of the service user.

The service can comprise the delivery of physical or electronic goods or services, but can also represent any other relationship between the service user and the service provider for which attributability is desired, such as passing through a security checkpoint.

Accordingly, service software, in the context pertaining to the invention, is understood to be any software, during the use of which by various users, attributability is desired or necessary, due, for example, to legally binding effects, such as during mobile electronic commerce and electronic auctions, during interaction with government officials and information and service providers, during the use of protected information or locations of businesses, or during the use of personal data, such as personnel time documentation.

Attributability, in this sense, can comprise various details, such as the details of an ordered service in connection with electronic commerce, location and time and, usually, the identity of the service user and the provider of the service and, if applicable, other parties involved in connection with passing through a security checkpoint, and, if applicable, the more general establishment of a relationship between the service user and the service provider. Parties with an interest in attributability can be the service provider and the service user or, if applicable, both parties.

The Internet and electronic commerce are become increasingly widespread, and many services, such as products and services, are offered via computers. In many cases, Internet browser software runs on these computers which itself accesses servers on which details are stored relating to the service being offered. A potential service user assumes that he is scrolling through the range of products or services offered, and may be required to enter data specifying the details of orders. This is normally done by filling out an electronic form. Completing the form often consists of selecting options within the range of products or services and entering personal data, such as identity, address, and bank account information. Accordingly, a special implementation of the invention is oriented toward the use of Internet browser software on the service computer.

A flow diagram that can be implemented using Internet browser software also exists in connection with services other than the direct purchase of a service or product. Examples include the offering of non-commercial services, such as by a government agency, or services associated with advertising or sales development, such the ordering of a free catalog. Another example is the conclusion of a non-commercial, legal contract between the party represented by the service computer and the service user, such as a confidentiality agreement, as an example of commercial and business procedures that are to be attributable. Internet browser software is less likely to be used for other procedures involving the execution of methods and systems of the invention, such as passing through security checkpoints, as described, or personnel time documentation. Which methods and systems of the invention are or are not executed using the implementation oriented toward Internet browser software must be decided on a case-by-case basis based on, for example, existing business practices.

Another exemplary implementation relates to electronic auctions, in which the roles of seller and buyer, in the commercial sense, can be distributed in different ways. The offer by the party that provides the software can be restricted to providing the virtual auction house, i.e., the means to enable things to be offered at auction and bids to be submitted; the role of the service user can consist in consenting to the terms of the auction and submitting bids and, if applicable, offering something for sale at auction.

In addition, there are situations in which computers offering services are so-called “embedded systems,” i.e., are integrated into surrounding machinery. Examples include copying machines and vending machines that are used by service users.

In many cases, it is neither desirable nor feasible, from the perspective of the service user and/or the perspective of the provider of the service, for a service user who is traveling to have direct manual access to the computer offering the service and to its periphery. Examples include computer monitors that are installed behind windowpanes or display windows, such as in closed shops, and continue to offer a service (such as booking a trip) outside normal business hours, computer systems that are part of networks critical to security, computers in public places to which service users do not readily entrust data critical to security, and devices at which brief transactions are performed, where users do not wish to spend very much time entering personal data, such as vending machines.

Attributability, in the context of the invention, refers to the possibility of details of the inventive use of a service software being verifiably documented, to a desired extent, for the service user and/or provider of the service. To this end, the method according to the invention utilizes the methods, known in the art, of digital signature and the use of digital certificates.

The security objective of attributability is generally known from computer-supported communication as having the character of establishing a contract or having legally binding elements, such as during electronic commerce, where it is necessary to ensure that negotiated elements of a contract (e.g., transmitted data and triggered functions), can be attributed to the contracting parties, and the identities of the contracting parties and, if applicable, others involved in the process, are unquestionable. In normal cases, what is to be attributed is concretely transmitted data or, if applicable, simply the occurrence of a communication and/or its circumstances, such as the time of said communication. During the conventional conclusion of contracts, this occurs when the contents of the contract are authenticated in a manner precluding forgery and the signatures are “secured” (filed or checked using presented documents or documents on file, such as identification cards). In the context of computer communication, attributability is secured, according to the state of the art, by means of so-called digital signatures. Said signatures are based on asymmetrical or “public-key” coding procedures, in which different keys are necessary for encoding and decoding, of which one is kept secret and the other is made generally known to the public.

Digital signatures are encoded checksums of the data to which the signature is to be applied, so that the data of the checksum can be clearly reproduced by recipients and third parties, where neither the original data nor other meaningful data having the same checksum can be construed from the checksum with a worthwhile amount of effort. Moreover, the encoding of the checksum can only be performed, with a worthwhile amount of effort, by the original sender using his secret code, and the checksum can be decoded by the recipient (and third parties) with knowledge of a public code corresponding to the secret code.

A digital signature is checked by decoding it by means of public keys and by comparing the decoded signature with the reproduced checksum. Reliable digital signatures are designed to foil attacks such as, for example, forgery of a signature, falsification of signed data, or denying the authorship of information.

As a condition of the last item, it must be possible to prevent someone from denying authorship of a public key that is used. Digital certificates, in this context, refer to data on the identity of a party participating in computer-supported information, usually including a public key to be used to check digital signatures, and usually digitally signed by a trustworthy party who guarantees the accuracy of the contents of the certificate. Certificate standard X.509 and the SHA and MD5 digital signature processes, which are used in the method according to the invention, reflect the state of the art.

Mobile hand-held devices, systems for wireless communication and methods for digital autographing are elements of the present invention and are widely disseminated. Thus far, however, a satisfactory solution that does justice to requirements does not exist for the many applications of mobile electronic commerce mentioned above and, more generally, of attributable mobile access to computers.

With consideration for this state of the art, implementations provide a system and a method for wireless, attributable access to computer-based services that satisfy the requirements described above, in connection with, for example, mobile electronic commerce. In these processes, the identity of the participating parties, as well as data relating to the service, are to be transmitted in an attributable manner and capable of being captured by the participating parties. Security requirements with respect to integrity and security may also be accounted for.

In a method according to the invention for wireless, attributable access to computer-based services, by means of a mobile hand-held device, by a service user, a service software runs on a service computer, enabling a service provider to provide a service to potential service users temporarily located within the range of a service computer. A service user located within the range of a service computer can access the service software by means of a service entry. To this end, the service user requires a personal, mobile hand-held device, which comprises a standard input/output and, preferably, a mimic function for interactive entry of service data for the service software and programs for access to service. The mobile hand-held device for accessing a service is connected to a service computer through a wireless connection. The process of using the service itself and, if applicable, data describing said process are exchanged, in an attributable manner, by the service computer and the mobile hand-held device using digital signatures. For the reciprocal disclosure of the identity and characteristics of the units involved in the use of the service, the mobile handheld device and the service computer may, if applicable, exchange digital certificates concerning the service user and the service software implementing the service, and thus concerning the service itself, as well as information concerning the mobile hand-held device and the service computer.

A method of this nature is suitable for applications of mobile electronic commerce and, furthermore, for all applications of mobile computing for which attributability is desired. In particular, this applies to applications in which the service is provided by a-business, a government agency, a provider of marketing or advertising documents, an auction house or a device, especially a copying machine, a vending machine, or a personnel time documentation device. In preferred implementations, mobile hand-held devices may include mobile telephones, which are widespread, palmtop pocket computers, or similar devices.

The invention features other advantages in addition to the above. When accessing a service and concluding the contract associated with said service and/or transmitting a digital signature to sign a document electronically, the service user can use a mobile hand-held device he considers to be trustworthy, such as his own mobile telephone, and is not obliged to entrust unfamiliar facilities with confidential data and codes, etc. In addition, he can store the concluded, digitally countersigned process in his mobile hand-held device and take it home for verification purposes.

According to a further advantageous implementation, it can be provided that the data concerning the identity of the service provider and the service user, and the details of the connection, are verified either immediately or subsequently.

In contrast to conventional mobile commerce, the present invention possesses, among other things, the following features. First, it is oriented toward applications that are limited in the sense that the buyer and/or service user keeps with him a personal electronic device, namely the mobile hand-held device. He can own the hand-held device or it can be assigned to him temporarily, such as at the entrance of a shop or shopping center, for making purchases therein or for accessing other services. Second, the scope of application is expanded, as the invention supports any type of computer-supported communication between a service user, e.g., his personal mobile hand-held device, and a service computer temporarily accessed by the service user. This includes, for example, business relationships and transactions executed in a computer-supported manner between companies and employees or third parties, especially customers, suppliers or visitors who are located on company property or otherwise in spatial proximity to computers and software, which is configured as service software according to the invention, when these transactions are to be attributable. The latter is the case, for example, during passage through security checkpoints, in connection with the documentation of (work) time, or during the conclusion of a confidentiality agreement or a negotiated contract.

In the following, the invention is explained in greater detail on the basis of exemplary implementations depicted in the figures. The special features described therein can be applied individually, or in combination with one another to create preferred implementations of the invention.

According to one general aspect, a presence of a mobile computing device is detected within a pre-determined spatial proximity of a service-providing computing device, via a wireless connection, a user of the mobile computing device is authenticated, via the wireless connection. A service option is provided to the user, using the wireless connection, the mobile computing device, and the service-providing computing device, and a selection of the service option that is input by the user using the mobile computing device is accepted.

Implementations may have one or more of the following features. For example, in accepting the selection of the service option, wirelessly-transmitted data input by an input format that is compatible with the mobile computing device may be converted into an output format that is compatible with the service computer.

Alternatively in accepting the selection of the service option, the selection may be input from an input module of the mobile computing device that includes an inertial navigation system operable to detect a movement of the mobile computing device.

The mobile computing device may include a hand-held computing device. The hand-held computing device may include a mobile telephone, or a personal digital assistant (PDA).

The wireless connection may be established using infrared communications. Also, the wireless connection may be established using Radio Frequency (RF) communications, such as the Bluetooth communications protocol.

In accepting the selection of the service option, the selection may be input from an input module of the mobile computing device, wherein the input module includes a reading device. The reading device may include a card reader that inputs information magnetically stored on a card.

The wireless connection may be established using an adaptor module associated with the mobile computing device.

In providing the service to the user authentication information input by and associated with the user may be accepted into the mobile computing device. The authentication information may include biometric identification associated with the-user, or digitally-autographed data, or data included in a first digital certificate that is associated with the user (where a scope of the service option is determined based on attributes of the first digital certificate), or a second digital certificate that is associated with the service-providing computing device.

In providing the service option to the user encrypted service information may be exchanged between the mobile computing device and the service-providing computing device, via the wireless connection.

According to another general aspect, an apparatus comprising a storage medium has instructions stored thereon, and the instructions include a first code segment for exchanging a first signal between a service-providing computer and a mobile computing device, where the service-providing computer and the mobile computing device are within a predetermined distance of one another, a second code segment for establishing a secure wireless connection between the service-providing computer and the mobile computing device, the secure wireless connection based on a second signal that is input from a user of the mobile computing device using an input module associated with the mobile computing device, a third code segment for matching an input modality associated with the input module of the mobile computing device with an output modality of the service-providing computer, and a fourth code segment for providing a service to the user, based on a request entered by the user by way of the input module and the input modality.

Implementations may have one or more of the following features. For example, the input module may include an inertial navigation system operable to detect a movement of the mobile computing device, or may include a reading device.

The second code segment may be associated with an adaptor module associated with the mobile computing device. Also, the second code segment may include a fifth code segment for exchanging authentication information associated with the user. In this case, the authentication information may include a digital certificate associated with the user.

According to another general aspect, a system includes an input system that is operable to detect presence of a mobile computing device within a predetermined spatial proximity and establish a wireless connection with the mobile computing device, a service module operable to provide a service to a user of the mobile computing device, via the wireless connection and while the mobile computing device remains within the predetermined spatial proximity, and an output system operable to interact with the input system and the service module to thereby present service information to the user, and further operable to present user information that is input by the user using an input module of the mobile computing device.

Implementations may have one or more of the following features. For example, the input system may be further operable to convert the user information using an input technique associated with the input module into an output format that is compatible with the output system. In this case, the input technique may be made to emulate pointing-device control of a cursor presented by the output system.

The input module may include an inertial navigation system operable to detect a movement of the mobile computing device. In this case, the inertial navigation system may convert the movement of the mobile computing device into a cursor movement presented on the output system.

The input system may establish the wireless connection based on authentication information associated with the user.

The service information may include a legal contract and an agreement selection, and the user information may act on the agreement information to thereby ratify the legal contract.

According to another general aspect, in a system for allowing a user to negotiate an electronic transaction, where the system includes a mobile computing device, the mobile computing device includes an input module operable to input authentication information and transaction information associated with the user, the transaction information including transaction instructions for completing the transaction, a wireless connection module operable to establish a wireless connection with a transaction server, based on the authentication information and upon a determination that the mobile computing device is within a pre-determined distance of the transaction server, a modality-mapping module operable to translate the transaction instructions from an input mode that is compatible with the input module to an output mode that is compatible with a presentation device associated with the transaction server, whereby the transaction instructions are reflected on the presentation device, and a transceiver operable to exchange the authentication information and the transaction information with the transaction server, whereby the user selects an item for purchase and purchases the item.

Implementations may have one or more of the following features. For example, the presentation device may be operable to present an Internet browser, where the Internet browser presents the transaction information. The transaction instructions may include content of a form filled out by the user, wherein the content is collected from the form using a plug-in associated with the Internet browser.

According to another general aspect, a system includes means for establishing a wireless connection between a mobile computer and a service computer, where the wireless connection is established based on authentication information associated with a user of the mobile computer and input using an input module associated with the mobile computer, means for presenting a service option, where the means for presenting is associated with the service computer, and means for accepting a service selection, in response to the service option, from the user, where the means for accepting is compatible with the means for presenting, to thereby present the service selection to the user, using the means for presenting.

Implementations may have one or more of the following features. For example, the means for establishing the wireless connection may include a means for establishing a Radio Frequency (RF) connection. In this case, the means for establishing the wireless connection may include a means for establishing a Bluetooth wireless connection.

The means for establishing the wireless connection may include a means for establishing an infrared connection.

The means for presenting may include a display, and/or an Internet browser.

The means for accepting may include means for communicating with an inertial navigation system operable to detect a movement of the mobile computer.

According to another general aspect, a method for wireless, attributable access to computer-based services, by means of a mobile hand-held device, by a service user, includes the following features. A service software runs on one or several networked service computers to provide a service by a service provider for potential service users temporarily located in a vicinity of a local service computer, and a service user located in the vicinity of the local service computer can wirelessly access the service software, in which the mobile hand-held device is permanently in a possession of the service user or is temporarily assigned to the service user, and entries into the service software by the service user take place through a standard input/output of the mobile hand-held device. Further, for a purpose of data exchange, components of a service port on both the mobile hand-held device and the local service computer cooperate, using components for wireless communication, wherein those details whose attributability is to be secured are sent, provided with a digital signature, to a party desiring attributability or, in a case of a desire for attributability on a part of both parties, are countersigned by a recipient, if applicable, and returned.

Implementations may have one or more of the following features. For example, data, especially concerning an identity and a valid public key, are transmitted in the form of digital certificates, especially transmitted by the mobile hand-held device to the service computer as an application certificate for the service user and/or as a system certificate for the mobile hand-held device, wherein the certificates themselves can be replaced by information on storage locations of these certificates, and transmitted by a service computer to the mobile hand-held device as a system certificate for the local service computer and/or as an application certificate for the service software and for the service. Independently certified sub-components are contained in an application or system certificate of the invention in the form of several independent certificate, and each individual certificate is optional, and the information to be authenticated on a case-by-case basis for the purpose of attributability is combined into a transaction data set which, if attributability is desired on the part of the service user, is authenticated by the service computer and transmitted to the mobile handheld device and, if attributability is desired on the part of the service, and therefore the service software, is authenticated in the mobile hand-held device and transmitted to a desired extent.

A mimic function may be connected between the standard input/output of the mobile hand-held device and the service input of the service software, ahead of the service port on the mobile hand-held device, which maps input means in place in the mobile hand-held device onto the input means provided for the service software and expected by the service input.

The mimic function in the mobile hand-held device may contain an inertial navigation system based on the mode of operation of an acceleration meter or a gyroscope, for recording the movement of the mobile hand-held device-by the service user, and derives data therefrom for the service input, which can be reproduced as pointer movements on a service output monitor.

The service software on the local service computer may be featured as commercial Internet browser software and supplemented with software whose interface to the Internet browser software is executed in standardized form as a plug-in, and the service software may be developed using software, document description and programming languages commonly found on the Internet. The service output of the service software may be occur on a monitor visible to the service user and/or other channels perceptible to the service user, and the portion of the service input for the service software not stored in advance is converted by the mobile hand-held device into matching data.

Data for recurring entries into the service software may be stored in the mobile handheld device, temporarily or permanently, as application certificates, system certificates, additional personal characteristics or service data, and such data for recurring entries may be validated prior to use when using data or functions considered temporary from the perspective of the mobile hand-held device, or indispensable components of the data for recurring entries or other data or functions that are indispensable to validity and are not made available or are only made available for a brief period of validity in the mobile hand-held device. The data or functions considered temporary from the perspective of the mobile handheld device or the components performing functions may be made completely or partly accessible through reading devices or biometric sensors, or connections to other standard or embedded computers delivering these data or functions, unless they are to be entered through the standard input/output of the mobile hand-held device.

The wireless connection between the mobile hand-held device and the service computer may contain the phases of greeting, negotiation and contract conclusion, wherein each of the consecutive phases of negotiation and contract conclusion represents a service use combined from the perspective of attributability, and multiple phases of service use can follow a greeting. The greeting phase may begin with the discovery phase, which establishes an underlying wireless connection, which in turn may be automatically initiated when the service user comes into proximity to a local service computer, overlapping with or followed by the security handshake phase, wherein options for the service use phases can be negotiated. Options relating to allowable service inputs can be negotiated, as well as the mapping of the input means available in the mobile hand-held device onto the negotiated input means by a mimic function, wherein, in the optional negotiation phase, details of service use are determined, in that recurring entries and/or data entered through the standard input/output are transmitted with the aid of the service port and the wireless connection, and are made accessible through the service input of the service software, possibly alternating with outputs at the service output. In the contract conclusion phase, the attributability of important communication contents may be ensured by digital authentication and transmission of these contents and, if applicable and necessary, repeated digital authentication and return transmission, wherein the service user consents to the performance of attributable communication, in accordance with the provisions of valid laws, to a minimum extent, such as at least once for similar, consecutive service uses or at least once per service use, in that he performs entries through the standard input/output and, if applicable, the mimic function, and/or makes data or functions available through a reading device in a manner from which the consent of the service user to the performance of an attributable communication and subsequent service can derived. Upon arrival of a transaction data set authenticated and transmitted by the service software, it may be displayed at the standard input/output of the mobile hand-held device to be checked by the service user, together with the request for confirmation of validity by the service user as a condition of the authentication and return transfer performed on his behalf.

The wireless connection may be executed as a local connection between the mobile hand-held device and local service computer, while using the standards of the Bluetooth™ SIG, or, alternatively, in accordance with other standards for wireless local communication.

The wireless connection may be executed as a connection through a public wireless network, wherein the service port can, in addition to being installed on the portable hand-held device and the local service computer, be distributed among other service computers, and the connection can also comprise wired segments.

According to another general aspect, a system for implementing a method for wireless, attributable access to computer-based services, by means of a mobile hand-held device, by a service user includes one or more networked service computers, on which a service software for the provision of a service by a service provider to potential service users temporarily located in the range of the local service computer runs, and on which a service user located in the range of the local service computer can wirelessly access the service software, a mobile hand-held device, which is permanently in the possession of the service user or is temporarily assigned to said user and comprises a standard input/output and, optionally, a mimic component for conversion of entries made by the service user to correspond to the input means of the service software and reading devices and/or local memories, especially for an application certificate, a system certificate, personal characteristics, and/or service data, distributed cooperative components for service ports and wireless connections on a mobile hand-held device and selected service computers, through which data for more precisely determining the service use are transmitted from the mobile hand-held device to the local service computer and data relating to communication processes and attributability are exchanged.

Implementations may have one or more of the following features. For example, the local service computer may be embedded in a device.

The details of one or more implementations are set forth in the accompanying drawings and the description below. Other features will be apparent from the description and drawings, and from the claims.

### DESCRIPTION OF DRAWINGS

FIG. 1 depicts a system according to the invention.

FIG. 2 depicts a protocol relating to FIG. 1.

FIG. 3 depicts a mobile telephone equipped in accordance with the invention.

FIG. 4 depicts the time progression of a so-called handshake.

FIG. 5 depicts an expanded portrayal of a system according to the invention.

Like reference symbols in the various drawings indicate like elements.

### DETAILED DESCRIPTION

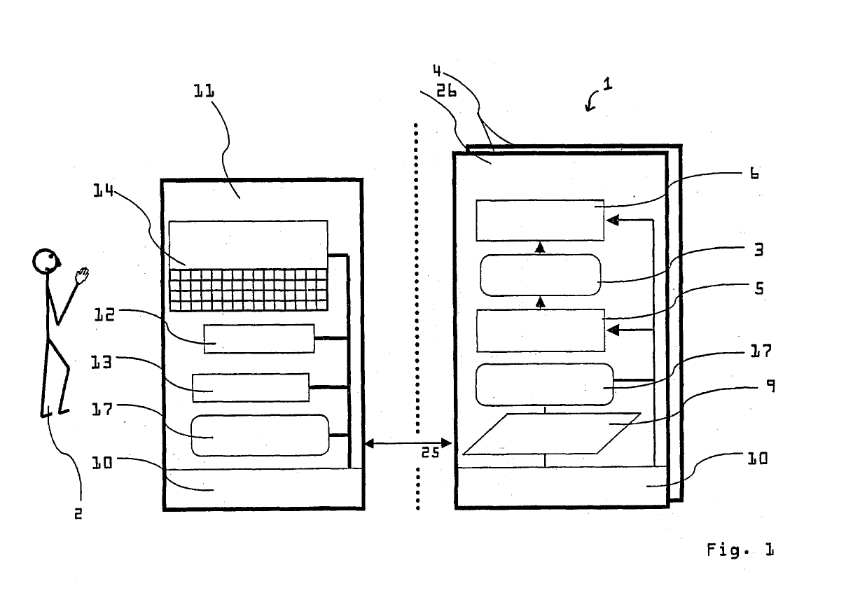

FIG. 1 illustrates a method according to the invention and a corresponding system for the wireless, touch-free, attributable and forgery-proof access to computer-based services 1 by means of a mobile hand-held device 11 by a service user 3, who is temporarily located within visual or audible range of a local service computer 26. The service computers 4, which can also be part of a computer network, especially the Internet, offer a service 1, and the service user 2 is a potential user of the service 1.

In the implementation depicted in FIG. 1, two service computers 4 are present, one of which is a special, namely local, service computer 26. In the context of the invention, a local service computer 26 is defined as a computer on which part or all of the service software 3 runs, and which is disposed in proximity to the service user 2 while being used by said service user, possibly together with other components of an intranet or the Internet, which can be involved in the service 1 and the transmission of the service 1.

In this process, the local service computer 26 can be integrated as an “embedded system” into a device, such as a vending machine or a copying machine. In this process, the local service computer 26 is a service computer which may be in direct wireless communication with the mobile hand-held device 11 of the service user 2.

The service software 3 comprises the computer software and/or firmware involved in the service 1, including all data and media accessed in connection with the service 1. This software can be distributed among, i.e., run on, the local service computer 26 and one or more additionally-connected service computers 4. The latter is the case, for example, when an Internet browser connected to a remote server is running on the local service computer 26.

The local service computer 26 advantageously comprises a means of service output 6 for the transmission of information about the service 1 to the service user 2. In general, this refers to the means of display that is used and equipment in the local service computer 26 designed to transmit information to the service user 2. In a preferred implementation, the means of service output 6 comprises a monitor visible to the service user 2, together with a display system (based on, for example, window technology) of the local operating system, and the standard service output of an Internet browser.

A standard Internet browser software, such as Microsoft™ Internet Expl or Netscape™ Navigator, can be used as the service software 3, which runs on a standard PC™ with monitor, on the local service computer 26. Suitable web servers, such as Apache database servers, etc., as used in standard, Web-based service software, can run on additional service computers 4 and/or on the local service computer 26.

The term “Internet browser” is a common expression that refers to software capable of displaying multimedia documents (so-called Word Wide Web or WWW or Web documents), which are stored on Internet computers, comply with suitable standards, and may be created by the World Wide Web Consortium, or W3C. Microsoft™ Internet Explorer™ and Netscape Navigator are known examples of such Internet browsers. The current preferred language for describing such documents is the so-called Hypertext Transfer Protocol (HTML) family, although other formats and protocols, such as the Extensible Markup Language (“XML”), XHTML and File Transfer Protocol (“FTP”), are also possible.

The local service computer 26 allows for the service entry 5 to control the service software 3. In the context of the invention, this includes all means suitable for converting wirelessly-transmitted data into interactive entries at the local service computer 26, i.e., all means and devices that are used on the local service computer 26 to forward inputs transmitted by the service user 2 to the service software 3.

In one implementation, the mimic function 12 imitates standard input means of the mobile hand-held device 11, such as function buttons of a mobile telephone, on standard input means of the local service computer 26, especially keyboard entries and mouse movements. In this manner, the service user can operate the service software 3 in a manner with which he or she is familiar.

For the same reason, it is advantageous when entries made by the service user 2 using the mobile hand-held device 11 are converted into mouse movements on a monitor of the local service computer 26 viewable to the service user 2. Such entries can be performed using standard means 14 of input and output that normally exist on a mobile hand-held device 11, such as the letter and number keypads, cursor keys, a mouse or a device that simulates mouse movements, such as a pen or touch panel. Other entries, such as voiceactivated control, are possible, just as the service output 6 can, for example, in addition to the implementations described above, be designed as a voice, sound, or music output.

In a preferred implementation, the mimic function 12 comprises an inertial navigation system for recording the movement of the mobile hand-held device by the service user 2, and for generating service entries 5 as a factor thereof. Such an inertial navigation system is used to detect how a service user 2 moves the mobile hand-held device 11 in the air; these movements are converted into mouse movements and transmitted to the service input 5 through the wireless connection 10 and the service port 17. In this process, a specific key on the keypad of the mobile hand-held device 11 can preferably be used to mimic a left-hand mouse click.

According to a preferred implementation, an inertial navigation system of a mimic function 12 features an acceleration meter or a gyroscope. The construction of conventional computer mice (pointing devices) that can be used in the air and are based on devices that measure the acceleration or rotation of the mouse is known in the art. Such devices can be manufactured as micro devices and therefore be integrated into or attached to a mobile hand-held device 11. Miniaturized acceleration meters are obtainable from, for example, Analog Devices, Norwood, Mass. USA. A mouse based on the gyroscope system (in which a micro acceleration meter manufactured by Gyration Inc., Saratoga, Calif., is used) was proposed by Gyropoint Inc., Saratoga, Calif.

The mimic function (12) for keypad entries can utilize the standard input means 14 that exist on the hand-held device 11. If the mobile hand-held device 11 is a wireless telephone that features only a numeric keypad, numeric keys can be used to enter both numeric data, which are directly assigned, and alphanumeric entries, as is the case, for example, of telephone keys. In portable pocket computers, the device-specific input means are dependent upon the type of device, and may comprise, for example, a pen featuring handwriting recognition technology, a miniature keypad, etc. The service port 17 and the wireless connection 10 are used to transmit the entries to the service input of the local service computer 26.

In summary, the term mimic function 12, as it is used in the context of the invention, refers to the means of mapping the interactive entries made into the mobile hand-held device by the service user 2 onto mimicked interactive entries in the service software 3, provided the standard input means/output on the mobile hand-held device differ from those expected in the service input 5. If the service input 5 is based on keypad entries and mouse movements or mouse actions, the mimic function 12 must convert relevant entries made by means of the mobile hand-held device 11 into these types of entries.

Thus, a special advantage achievable with the invention consists in the fact that the service entries 5, such as mouse and keypad entries, to be made at a local service computer 26 in accordance with the state of the art are performed wirelessly from the mobile hand-held device 11, without the service user 2 having direct access to the local service computer 26. In the preferred implementation, the standard output of the local service computer 26 must not be transmitted or diverted to the mobile hand-held device 11, as the service user 2 located in the vicinity of the local service computer 26 can perceive the standard output of the local service computer 26, such as a monitor display or audio output.

In the context of the invention, the term service output 17 refers to all software and/or firmware, including all corresponding data and media, on the mobile hand-held device 11 and the local service computer 26, which contribute to the correct functioning of the method according to the invention in the following manner. This software guarantees the coordinated use of certificates, personal characteristics 15, service data 16, means of standard input/output 14, possible reading devices 13, additional plug-in features, the mimic function 12, and wireless communication 10 on the mobile hand-held device 11, as well as wireless communication 10 and service entry 5 on the local service computer 26, as well as the transaction data set 9 to permit access to the service software 3 from the mobile hand-held device 11.

If local wireless communication is used for the connection between the hand-held device 11 and the local service computer 26, the service port 17 is implemented on both the hand-held device 11 and the local service computer 26. If a public wireless telephone network is used and the local service computer 26 is not equipped with the corresponding hardware for wireless communication, for economic reasons, for example, an additional intermediately-connected module for the service port 17 may be needed on the computer with which the mobile hand-held device 11 enters into communication.

In some implementations, the mobile hand-held device 11 is a mobile telephone or a palmtop pocket computer. In general, it is a portable electronic device, namely the computer that is taken along and, if applicable, owned by (or otherwise associated with) the service user 2. This computer can be integrated into a device, such as into a mobile telephone. In addition to the means of standard input/output 14 and the service port 17 by means of the wireless connection 10, the mobile hand-held device 11 can also comprise the mimic function 12 and one or more reading devices 13.

A reading device 13 of this nature generally refers to the hardware and the functions used to either read data from natural or artificial data storage devices or to establish connections with external functions. The reading of data applies, for example, to biometric data or external data storage devices, such as fingerprints, credit cards, etc. “External functions” refers to objects to be read, which contain code and optional execution logic, such as chip cards (cash cards, SmartCards).

The use of a reading device 13 is not absolutely necessary to execute the invention. However, it is practical to use a credit card reader, for example. In this case, the credit card and the corresponding PIN can be used to automatically cause the software of the service port 17 on the hand-held device 11 to link a secret code to an application certificate for the holder of the card, ideally a certificate issued by the credit card company, to the service user 2 of the hand-held device 11. This option is practical for the broad distribution of device according to the invention. Service users 2 without credit card readers can then take advantage of a portion of the services 1 generally offered by service providers. Services 1 critical to security, such as those associated with high costs, can then be limited to service users 2 who own a hand-held device 11 with a credit card reader and a certificate issued by the credit card company.

In some implementations, the wireless connection 10 between the hand-held device 11 and the local service computer 26 can be featured as a local connection, or take place through a public telephone network. The wireless connection 10 includes the hardware and software parts of both the hand-held device 11 and the service computer 4 and/or 26, which are used to transmit data back and forth between said hand-held device and service computer.

A local wireless connection that connects the hand-held device 11 with the local service computer 26, either by radio or by infrared, is preferred. Many conventional handheld devices, such as mobile telephones or palmtops, already feature corresponding equipment for communicating locally, using, for example, of the Bluetooth™ process or infrared interfaces. Depending on the technology used for the wireless connection 10, basic identifications and security functions designed to provide data protection and data security can also be implemented in the module for the wireless connection 10, instead of in the service software 3 and service port 17.

According to another advantage feature, it can be provided that the wireless connection 10 between the mobile hand-held device 11 and the service computer 4, 26 is established automatically when the service user 2 comes into proximity to the local service computer 26. This is especially advantageous when the wireless connection 10 is local.

In the context of the invention, the use of public wireless communication networks, such as GSM, UMTS or paging networks, is generally advisable only if the hand-held device 11 or the local service computer (26) does not contain a device for local wireless connection, as communication via public networks generally requires the payment of a fee. The “detour” through the public network can be advantageous in terms of achieving adequate market penetration for service software, as long as mobile telephones do not possess comprehensive options for local wireless communication, as is the case with so-called SmartPhones with Bluetooth™ communication capabilities or with other, possibly future, developments.

In a preferred implementation, the wireless connection 10 is accomplished by means of a Bluetooth™ sending and receiving device. In this case, a public telephone network is not needed. Both the hand-held device 10 and the local service computer 26 are equipped with a sending and receiving device. The so-called Bluetooth™ Host Controller Interface can be advantageously used to transmit entries made by the service user 2, coming from the mimic function 12, to the local service computer 26.

Bluetooth™ is a wireless, short-range, digital communication technology, which is standardized and disseminated by the Bluetooth SIG, which comprises more than 1000 members, generally businesses. Bluetooth™ operates in the 2.4 GHz band, and the “frequency hopping” (FH) method is used. Its special attributes ensure that devices can establish contact with one another without manual manipulation when they come into proximity with one another, even when they are not yet “familiar” with one another (furthermore, no manual configuration steps are necessary).

Communication protocols building upon one another within the Bluetooth framework provide important functions, such as the actual signal transmission, secured communication relationships, exchange of device attributes, Internet-compatible communication, transmission of structured data using “OBEX” (object exchange), which is known from the infrared communication standard “IrDA,” etc. Bluetooth also supports, in elementary form, such protective objectives as confidentiality (using encoded communication) and authentication (at the device level, wherein the identity of the device, and not that of the software or user, is secured). The extent to which these objectives are in fact achieved has been widely discussed and criticized. Ultimately, security is not one of Bluetooth's primary claims, given the limited spatial scope and original usage scenarios (“cordless desktop”). The attributability claimed in this description may require additional measures. For security reasons, it is advantageous for the service user 2 to identify himself to the service computer 4, 26 by means of digitally autographed data. The digitally autographed data can advantageously be entered into the mobile hand-held device 11 by means of a reading device, especially a chip or credit card reader or a biometric sensor, and/or entered into the mobile hand-held device 11 by means of the standard means of entry 14 of the mobile hand-held device 11, especially in the form of a PIN or a password, or with a digital pen.

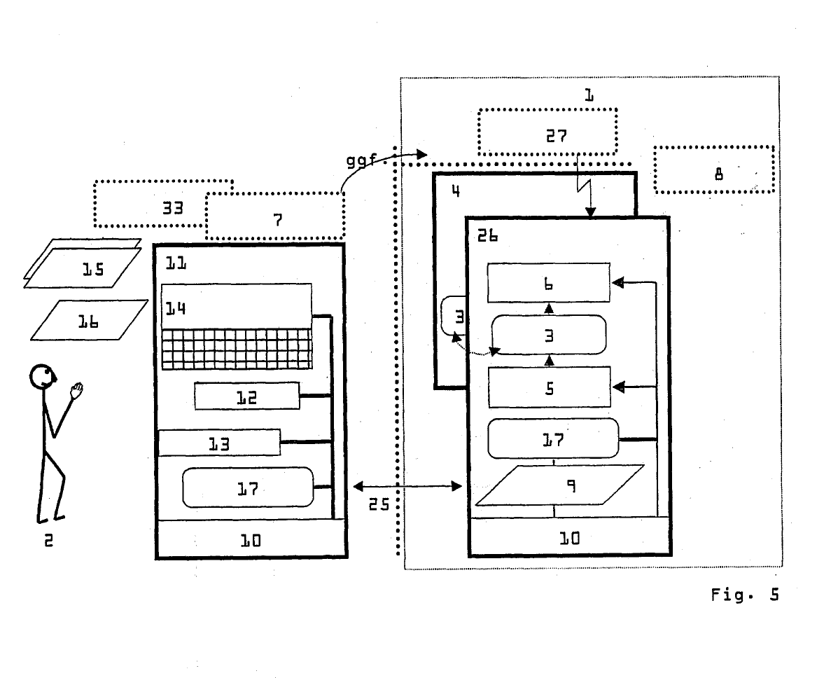

The application certificates involved in the method according to the invention advantageously comprise (see FIG. 5) a digital application certificate 7 for the service user 2 and/or a digital application certificate 27 for the service software 3 and, by extension, for the service 1. The use of the current standard for digital certificates, ISO standard X.509, is recommended. These certificates help verify the identity, authenticity and properties of the service software 3 and, by extension, of the service 1 and the service user 2. The decision by the service user 2 to utilize a specific service 1 can be made dependent on the existence of a corresponding application certificate or an application certificate with specific attributes. From the perspective of the provider of the service 1, the scope of services 1 offered can be made dependent on the existence of a digital certificate for the service user 2 or such an application certificate with specific attributes.

In a special implementation, it can be provided that the application certificate 7 for the service user 2 is stored on a computer connected to the Internet, and that the mobile handheld device 11 provides the digitally-autographed Internet address of the application certificate of the service user 2. Using the service port 17, the service software 3 can then scan the application certificate 7 of the service user 2 and verify the identity of the service user 2 by decoding the signature by means of the public key taken from the certificate.

According to an additional feature, it can be provided (as shown in FIG. 5) that a digital system certificate 33 for system components, such as software, hardware or inventive system additions to the mobile hand-held device 11, and/or a digital system certificate 8 for system components of the local service computer 26 be used. X.509 is also a standard that can be recommended for this purpose. These certificates serve to foster confidence in the non-local software to which a connection is established, especially the service port 17. The service port 17 can be implemented on the hand-held device 11 in such a way that it only accepts connections to correctly certified software for the service port 17 on the local service computer 26; this can also apply to the implementation of the service port 17 on the local service computer 26.

Each of the digital certificates 7, 8, 27, 33 can comprise several independent partial certificates, such as in the case of application certificates where different attributes of the service user 2 or the service 1 are described in different certificates, or in the case of system certificates where different system components are identified by different certificates.

The use of digital application certificates 7, 26 and system certificates 8, 33 is not absolutely necessary to execute the invention. In the case of legally binding agreements, the electronic version of which is supported by the present invention, it is frequently customary that the parties involved identify themselves, although whether and how this occurs depends on the circumstances of the case at issue. In the case of electronic commerce, in particular, it is becoming apparent that excessively strict regulation of the use of certificates has an inhibiting effect. In connection with the protective objective of “attributability,” certificates ensure that the authorship of public keys of the type used in digital signatures cannot be denied. In particular, these certificates can be used during establishment of a connection to establish trust in a transaction data set 9 to be used toward the end of service use 24.

Such a transaction data set 9 may be used in accordance with an additional feature. It contains data on the service use 24 of the service 1 by the service user 2, including identification of the service 1 and the service user 2. According to another possible feature, the transaction data set 9 at the end of a negotiation phase 22 is created and/or completed at the beginning of a contract conclusion phase 23. According to another feature, it can be provided that an Internet browser software used for the service port 17 on the local service computer 26 comprises a plug-in for generating a transaction data set 9.

The term “plug-in” refers to a standard method of supplementing browser software. The plug-in according to the invention generates a transaction data set 9, which is essential in the preferred implementation. It contains the content of the completed form, which is based on the Internet browser and is confirmed by the service user 2. In this context, the term “confirmed” refers to the action that causes the service port 17 to leave a negotiation stage 22 and prepare the phase of contract conclusion 23.

In the preferred implementation, confirmation occurs when the Internet browser is used in such a way that a form just displayed for the user is completed, which is normally accomplished by means of a mouse click on a specific control surface. This action is interrupted by the plug-in, and a transaction data set 9 that contains the contents of the form in a specific description is generated.

Another feature can consist in the fact that a personal characteristic 15 of the service user 2 is stored in the mobile hand-held device 11. Personal characteristics, in this sense, are data and/or functions that clearly identify the service user 2, as well as data that describe the service user 2 and can be scanned by the service software 3. Such personal characteristics 15 are, for example, the address, banking information, etc. For security reasons, it is possible to continue to provide that a portion of the personal characteristics 15 of the service user 2 is permanently stored and/or a portion is temporarily stored in the mobile hand-held device 11.

The permanent storage of personal characteristics 15 simplifies the use of the system by the service user 2. To protect personal data against modification or unauthorized use, it can be provided that the portion of the personal characteristics 15 permanently stored in the mobile hand-held device 11 is not sufficient for clearly attributable identification of the service user 2, so that modification or unauthorized use can only cause minor damage.

A temporarily-stored portion of personal characteristics 15 may be automatically deleted upon expiration of a predetermined period of time, preferably shortly after it has been entered or scanned into the hand-held device 11, or upon occurrence of a predetermined event, particularly following the conclusion of the use of service 1 or when the mobile handheld device 11 is switched off or set aside. In these cases, the temporary portion of the personal characteristics 15 must be re-entered or scanned to permit further use of the handheld device 11. It is advisable that highly sensitive data or functions be stored temporarily.

Means of standard input/output 14 or reading devices 13 can be used to enter or scan temporary personal characteristics 15 into the hand-held device 11. When means of standard input/output 14 are used, the service user 2 uses the normal input means and output of the hand-held device 11, such as a keypad or pen, to enter the temporary portion of his personal characteristics 15 (e.g., PIN, password, etc.).

When a reading device 13 is used, it is assumed that the service user 2 has an external medium on which the temporary personal characteristics 15 are available. Such external media can, for example, be plastic cards or body parts. The corresponding reading device 13, such as a biometric sensor or a chip or credit card reader, makes the applicable temporary portion of the personal characteristics 15 accessible to the hand-held device 11. The attribute of temporariness refers, in this regard, only to storage in the hand-held device 11, as the data (e.g., iris, fingerprint, credit card) are not temporary, but permanent, on the applicable external medium. This can result in a security risk that does not fall within the scope of the invention, such as when a credit card is lost or stolen. Such risks can be minimized if means of standard input/output 14 and reading devices 13 are used in combination, such as by combining a PIN with a credit card.

Further in FIG. 5, which, in particular, depicts the service data 16, information is described which, in addition to the personal characteristics 15, is transmitted to the service software 3 by the service user 2. This can also contain selection data relating to details of the accepted service 1. FIG. 5 also depicts the certificates discussed earlier.

As in the non-digital world, it is not meaningful, in the context of the invention, to firmly define in the invention the data and keys that are to be viewed as part of the certificates 7, 8, 27, 33, as personal characteristics 15, and as service data 16. Certificates are comparable to identification cards, personal characteristics 15 are comparable to documents that are kept on one's person and contain information that is frequently needed, and service data 16 are comparable to information that is provided on a case-by-case basis and must then be re-entered. These three categories can also vary from one case to the next in the context of non-electronic commerce. In non-electronic commerce, for example, whether a customer presents a reliable account card to provide his account information, pulls a piece of paper containing this information out of his pocket, or writes down the information again depends on common practice, habits and, possibly, the circumstances of the case in question.

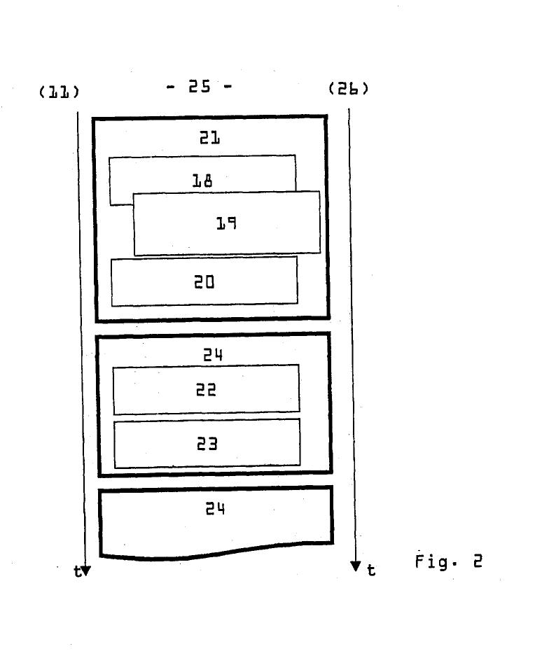

FIG. 2 depicts the time progression of a protocol 25 between a mobile hand-held device 11 and a local service computer 26. It advantageously comprises the steps of greeting 21, negotiation 22 and contract conclusion 23. According to an additional advantageous feature, it is proposed that the certificates are transmitted as part of the greeting 21 and service entries as part of the negotiation 22, and that contract conclusion 23 occurs when a specific control surface is activated by a mimicked mouse click. In the example shown, the greeting 21 comprises a discovery 18, a security handshake 19, and modality matching 20.

The discovery 18 comprises the procedures and protocols of the wireless communication 10 and other parts of the system, which the mobile hand-held device 11 and the service computer 4 or local service computer 26, and their relevant attributes, disclose to one another, and which also disclose the machine-readable details and, if applicable, the humanly comprehensible descriptions of the service software 3 and the service 1 for the mobile hand-held device 11.

The security handshake 19 comprises the procedures and protocols, by means of which the mobile hand-held device 11 and the service computer 4 or local service computer 26 disclose their identity to one another in digitally authenticated form, exchange system certificates 8, 33, exchange application certificates 7, 27, transmit the storage location of the application certificate for the hand-held device 11, determine the nature and scope of the communication elements to be digitally authenticated for the purposes of attributability, such as a transaction data set 9, agree on additional security procedures, such as a specific encoding procedure, and exchange keys as a factor of the remaining requirements.

The encoding of the transmitted data represents an advantageous option against forgery, eavesdropping or misuse of the data. However, encoding is not very important in application cases in which secrecy and confidentiality requirements are minimal. This is especially applicable to application cases in which transmission takes place through a local network, as protection is, in most cases, already provided in such networks, due to spatial limitations on eavesdropping activities.

The security handshake 19 can overlap with the phase of discovery 18, such as when an advanced wireless communication technology such as Bluetooth is used, as such technology includes the performance of at least a device authentication procedure, though not the entire required authentication procedure, as part of its pre-installed functions. Consequently, a system according to the invention that utilizes Bluetooth™ will perform the portion of the security handshake 19 associated with Bluetooth™ as part of the establishment of a connection at the device level, i.e., before the phase of discovery 18 has been concluded.

Modality matching 20 applies to the protocols and procedures that are used to exchange information concerning the following items: the means of service input offered by the local service computer 26, such as a mouse, numeric entries, alphanumeric entries, voice, etc., in addition to such search criteria as “mandatory,” “preferred,” “optional,” etc.; the input means, provided to the service user 2 by the hand-held device 11, of the mimic function 13, which are specified in analogy to the input means mentioned above in the form of such entries as <“mouse,” “preferred”> etc.; the specific input means to be used during the ensuing process and, if necessary, details concerning their use; the only input means that can be used are those that are offered on both the hand-held device 11 and the local service computer 26; available and expected options relating to the above-mentioned phase of service use 24; the specific options to be used during the ensuing process.

In the preferred implementation, the mimic function 12 projects entries made by the service user 2 onto mouse and keypad entries. In this case, the input means made available by the hand-held device 11 are referred to as<“mouse”,”> etc., even when, for example, an acceleration meter or gyroscope is used to mimic mouse movements, since conversion into mouse movements is critical to the service software 3. Other details, such as the name and version number of a document description language such as <HTML 1.1> can be exchanged in connection with modality matching 20 between the local service computer 26 and the hand-held device 11.

The negotiation 22 applies to the mimicked entries made by the service user 2 into the service software 3, which the mimic function 12 transmits to the service input 5 through the service port 17 and the wireless connection 10 with the intention of selecting and specifying all of the information needed to provide the applicable service 1, as well as other information requested or provided by the service user 2 in this context.

Contract conclusion 23 converts the request for a service 1 made by the service user during the negotiation 22, which has been temporary until this point, into a legally binding service order placed with the service software 3 and, therefore, with the service provider. The phase of contract conclusion 23 begins when the phase of negotiation 22 can be considered complete and the service user 2 triggers a specific action highlighted in the service software 3, such as clicking on a highlighted contact surface in an electronic form. In this process, clicking is accomplished by means of the standard input/output 4 and, if applicable, the mimic function 12, as described in connection with negotiation 22; the highlighted control surface can, for example, be labeled “Click here to send the order.” The transmission of forms by clicking on a highlighted contact surface is a common procedure in Internet browser software. In the preferred implementation of the invention described here, the process of contract conclusion 23 is inserted ahead of the software function normally linked to this clicking procedure.

As an option, a transaction data set 9 is generated by the service software 34 and/or the part of the service port 17 assigned to the service computer 4 and/or 26 as part of a recommended process. The transaction data set 9 is digitally authenticated with the digital signature of the service software 3, and is then authenticated by the service port 17. The first signature uses the private key that corresponds to the application certificate 27 for the service 1 and the service software 3. The second signature uses the private key that corresponds to the system certificate 8 for the local service computer 26. The transaction data set 9 is then transmitted to the mobile hand-held device 11 where, in analogy to the procedure on the local service computer 26, two signatures are added, one corresponding to the application certificate 7 for the service user 2 and the other to the system certificate 33 for the mobile hand-held device 11. In the opposite direction, it is generally necessary to transmit the signatures only, as the transaction data set 9 itself already exists in the local service computer 26. Each of the individual signatures is optional in the process described above.

Depending on the service 1, additional actions, which may require user entries, can be inserted between the end of the phase of negotiation 22 and the end of the phase of contract conclusion 23. Such actions can be the condition of final approval of the service described in the transaction data set 9 by the service user 2 and/or the party offering the service 1. In particular, the software for the service port 17 on the mobile hand-held device 11 can specifically ask the service user 2 to agree to the conclusion of the contract, by displaying, for example, a message such as “do you really wish to sign the form depicted on the display of the service computer? (yes/no)” or by providing a local display and asking for confirmation of the transaction data set. The party offering the service 1 can, for example, insert a payment procedure such as the “paybox” plan described initially. If all such additional actions have been completed and the transaction data set 9 between the local service computer 26 and the hand-held device 11 has been authenticated and transmitted back and forth, and if all required signatures have been verified, the legally binding agreement is considered concluded. In the communication protocol 25, it must be ensured, based on the state of the art and using, for example, receipt messages and time limits, that communication errors in connection with the wireless connection 10 do not lead to false interpretation of the process described above, i.e., that, for example, lost messages do not result in one side viewing contract conclusion as complete while the other views it as discontinued. In the especially advantageous implementation by means of Internet browser software described above, the software of the service port 17, which is based on a plug-in, triggers the return to the conventional procedure and permits the Internet browser software to transmit the form to the web server.

Service use 24 relates to the connection of the negotiation phase 22 with a subsequent contract conclusion 23 phase. A security handshake 19 phase and a modality matching 20 phase can be followed by several phases of service use 24. Termination of the communication is possible at any time. In particular, the communication can be terminated whenever a procedure or a data protocol cannot be completed successfully. Entries made by the service user 2 during the negotiation 22 can be cancelled if all data needed to describe the service request, realized in the special implementation as completion of a form, for example, can be obtained from the information stored in the hand-held device, such as personal characteristics 15. Even contract conclusion 23 can, on a case-by-case basis, be requested only once by the user for an entire series of communication procedures to be embodied as attributable, so that an entry by the service user 2 must not be requested for each procedure of this nature, such as in situations in which multiple occurrences of passing through a security checkpoint separated by brief time intervals are to be documented in an attributable manner for the person passing through the checkpoint.

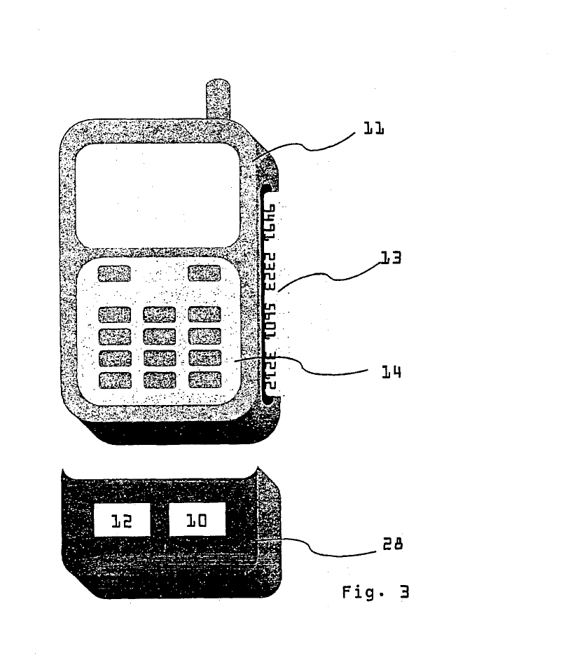

FIG. 3 depicts an implementation of a mobile hand-held device 11. Said device is a mobile telephone with a reading device 13 in the form of a credit card reader. It comprises an adapter module 28 that provides the functionality for local wireless connections 10. In the advantageous implementation described, said module can be configured in accordance with the Bluetooth™ communication standard. The adapter module 28 comprises a mimic function 12 in the form of an inertial navigation system, with which movements of the mobile hand-held device 11 are converted into mouse actions on the Internet browser of the local service computer 26, as well as other functionalities required for the method according to the invention. The adapter module 28 can be attached to the mobile hand-held device 11.

The classification of communication between the mobile hand-held device 11 and the local service computer 26 into the three categories of security handshake 19, negotiation 22 and contract conclusion 23 corresponds to normal business practice.

In an especially advantageous implementation of the method according to the invention, the transaction data set 9 combines all communication elements in the form of contract elements for which attributability is desired, and is authenticated by the two communicating parties. This is comparable to combining the receipts that a service user 2 normally receives in non-electronic commerce when using a credit card; the details of the service request, such as purchased items or services, are listed on a sales receipt, while customer and credit card data, including the invoice total, are listed on a transaction receipt. If there is a greater willingness to accept risk, credit card transactions can also be completed without receipts, e.g., for reasons of convenience or to avoid losing customers. For similar and other reasons, the use of the authenticated transaction data set can also be eliminated in the process of the invention, although use thereof is recommended. In addition to the use of document description languages, such as HTML or XML, other alternatives are also available for implementation of the invention, such as, in an advantageous implementation, a facsimile of the Internet browser window displayed on the screen in the form of a printable receipt comprising a set of image spots, which is also suitable for use as a digital signature.

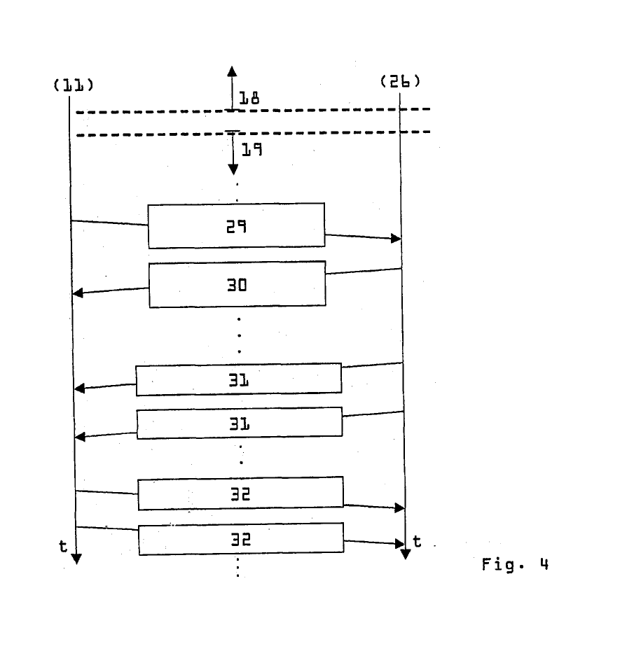

A preferred implementation of the security handshake 19 that begins at the end of the discovery 18 is portrayed in FIG. 4. With respect to the use of Bluetooth™ technology, it must be noted that, according to the state of the art, the Bluetooth^{TM} procedure only authenticates devices, not users. Bluetooth™ technology can be used as an adjunct on a case-by-case basis, so as, for example, to limit access to hand-held devices 11 distributed to potential service users 2 in closed environments (such as shops or exhibitions). The Bluetooth™ protocol and RMCOMM driver model are used in this implementation to directly connect the mobile hand-held device 11 with a keyboard and mouse driver on the local service computer 26, as well as with a driver that is part of the service port 17 on the local service computer 26. Secure communications, digital signatures and certificates based on the TLS standard (TLS=Transport Layer Security) can be used in this process. TLS is a commonly used Internet procedure for providing secure communication through non-secure Internet connections, and it is widely used in electronic commerce. TLS is heavily influenced by the SSL process (SSL=Secure Socket Layer), which is described in U.S. Pat. No. 5,756,390.

A variant of and addition to the proposed TLS Internet standard can be used as part of the service port 17 to implement the security handshake 19. This TSL variant can be loaded directly onto Bluetooth™ RFCOMM. Other implementations can be based on Point-to-point (“PPP”) or Transmission Control Protocol (“TCP”), for example.

In the described implementation, the TLS message “Client hello” 29 contains, for example, additional information about the legal validity associated with authentication of a transaction data set 9, i.e., the contractual provisions and terms, particularly an optional grace period within which a signed agreement can be revoked. This option is important for two reasons. On the one hand, different countries can have different fundamental legal provisions in this respect. For example, it can be provided by law that a contract concluded in electronic commerce can be revoked within at least four days. On the other hand, the mobile hand-held device 11 can or cannot feature means of locally displaying the transaction data set 9 to the service user 2 within the scope of contract conclusion 23. If this is not possible, the service user 2 can first read and personally verify the transaction data set 9 after having returned to his home or office. In this case, the provisions and terms to which the service user 2 wishes to agree can depend, for example, on the certificates. The corresponding behavior of the service port 17 on the hand-held device 111 can be determined in advance, at home, for example, as part of setting a so-called “profile” of the service user 2. The profile, in turn, can be initialized on the hand-held device 11 in connection with the software installation.

The TLS message “Server hello” 30 contains information on the meaning of the transaction data set 9 corresponding to the above. To successfully establish a connection, this information must correspond to the provisions and terms that the hand-held device 11 is prepared to approve based on the “Client hello” 29 message.

The TLS message “Server certificate” 31 is sent two times in sequence, once for the system certificate 8 and once for the application certificate 27 on the side of the local service computer 26. As described above, the use of individual certificates is optional in the context of the invention. System certificates, in this context, can be certified to simplify the instance corresponding to the respective application certificate, or vice-versa, wherein that which is to be certified is viewed as a higher-order certificate.

The TLS message “Client certificate” 32 is also sent two times in sequence, and authenticates the side represented by the mobile hand-held device 11 based on the system certificate 33 and the application certificate 7. In the preferred implementation, SHA is used for all digital signatures. It is a method suggested in the context of TLS, among other things, and is described in detail as the “Secure Hash Standard” (SHS) of the American National Institute of Standards and Technology (NIST). The known MD5 method is an option for alternative implementations, but is generally considered inferior to SHA.

The system certificates are used to authenticate the implementations of the service port 17 and, in particular, contain the public keys for verification of the two system-specific signatures of the transaction data sets 9. Additional encoding methods and keys are determined on the basis of the application certificates.

A number of implementations have been described. Nevertheless, it will be understood that various modifications may be. Accordingly, other implementations are within the scope of the following claims.

What is claimed is:

1. A method comprising:
detecting presence of a mobile computing device within a pre-determined spatial proximity of a service-providing computing device, via a wireless connection;
authenticating a user of the mobile computing device, via the wireless connection;
providing a service option to the user, using the wireless connection, the mobile computing device, and the service-providing computing device; and
accepting a selection of the service option that is input by the user using the mobile computing device.

2. The method of claim 1 wherein accepting the selection of the service option comprises converting wirelessly-transmitted data input by an input format that is compatible with the mobile computing device into an output format that is compatible with the service computer.

3. The method of claim 1 wherein accepting the selection of the service option comprises inputting the selection from an input module of the mobile computing device that includes an inertial navigation system operable to detect a movement of the mobile computing device.

4. The method of claim 1 wherein the mobile computing device includes a hand-held computing device.

5. The method of claim 4 wherein the hand-held computing device includes a mobile telephone.

6. The method of claim 4 wherein the hand-held computing device includes a personal digital assistant (PDA).

7. The method of claim 1 wherein the wireless connection is established using infrared communications.

8. The method of claim 1 wherein the wireless connection is established using Radio Frequency (RF) communications.

9. The method of claim 1 wherein the wireless connection is established using Bluetooth communications protocol.

10. The method of claim 1 wherein accepting the selection of the service option comprising inputting the selection from an input module of the mobile computing device, wherein the input module includes a reading device.

11. The method of claim 10 wherein the reading device includes a card reader that inputs information magnetically stored on a card.

12. The method of claim 1 wherein the wireless connection is established using an adaptor module associated with the mobile computing device.

13. The method of claim 1 wherein providing the service to the user comprises accepting authentication information input by and associated with the user into the mobile computing device.

14. The method of claim 13 wherein the authentication information includes biometric identification associated with the user.

15. The method of claim 13 wherein the authentication information includes digitallyautographed data.

16. The method of claim 13 wherein the authentication information includes data included in a first digital certificate that is associated with the user.

17. The method of claim 16 wherein a scope of the service option is determined based on attributes of the first digital certificate

18. The method of claim 13 wherein the authentication information includes data associated with a second digital certificate that is associated with the service-providing computing device.

19. The method of claim 1 wherein providing the service option to the user comprises exchanging encrypted service information between the mobile computing device and the service-providing computing device, via the wireless connection.

20. An apparatus comprising a storage medium having instructions stored thereon, the instructions including:
a first code segment for exchanging a first signal between a service-providing computer and a mobile computing device, where the service-providing computer and the mobile computing device are within a pre-determined distance of one another;
a second code segment for establishing a secure wireless connection between the service-providing computer and the mobile computing device, the secure wireless connection based on a second signal that is input from a user of the mobile computing device using an input module associated with the mobile computing device;
a third code segment for matching an input modality associated with the input module of the mobile computing device with an output modality of the service-providing computer; and
a fourth code segment for providing a service to the user, based on a request entered by the user by way of the input module and the input modality.

21. The apparatus of claim 20 wherein the input module includes an inertial navigation system operable to detect a movement of the mobile computing device.

22. The apparatus of claim 20 wherein the input module includes a reading device.

23. The apparatus of claim 20 wherein the second code segment is associated with an adaptor module associated with the mobile computing device.

24. The apparatus of claim 20 wherein the second code segment includes a fifth code segment for exchanging authentication information associated with the user.

25. The apparatus of claim 24 wherein the authentication information includes a digital certificate associated with the user.

26. A system comprising:
an input system that is operable to detect presence of a mobile computing device within a pre-determined spatial proximity and establish a wireless connection with the mobile computing device;
a service module operable to provide a service to a user of the mobile computing device, via the wireless connection and while the mobile computing device remains within the pre-determined spatial proximity; and
an output system operable to interact with the input system and the service module to thereby present service information to the user, and further operable to present user information that is input by the user using an input module of the mobile computing device.

27. The system of claim 26 wherein the input system is further operable to convert the user information using an input technique associated with the input module into an output format that is compatible with the output system.

28. The system of claim 27 wherein the input technique is made to emulate pointingdevice control of a cursor presented by the output system.

29. The system of claim 26 wherein the input module includes an inertial navigation system operable to detect a movement of the mobile computing device.

30. The system of claim 29 wherein the inertial navigation system converts the movement of the mobile computing device into a cursor movement presented on the output system.

31. The system of claim 26 wherein the input system establishes the wireless connection based on authentication information associated with the user.

32. The system of claim 26 wherein the service information includes a legal contract and an agreement selection, and the user information acts on the agreement information to thereby ratify the legal contract.

33. A system for allowing a user to negotiate an electronic transaction, the system comprising a mobile computing device, the mobile computing device including:
an input module operable to input authentication information and transaction information associated with the user, the transaction information including transaction instructions for completing the transaction;
a wireless connection module operable to establish a wireless connection with a transaction server, based on the authentication information and upon a determination that the mobile computing device is within a pre-determined distance of the transaction server;
a modality-mapping module operable to translate the transaction instructions from an input mode that is compatible with the input module to an output mode that is compatible with a presentation device associated with the transaction server, whereby the transaction instructions are reflected on the presentation device; and
a transceiver operable to exchange the authentication information and the transaction information with the transaction server, whereby the user selects an item for purchase and purchases the item.

34. The system of claim 33 wherein the presentation device is operable to present an Internet browser, where the Internet browser presents the transaction information.

35. The system of claim 33 wherein the transaction instructions include content of a form filled out by the user, wherein the content is collected from the form using a plug-in associated with the Internet browser.

36. A system comprising:
means for establishing a wireless connection between a mobile computer and a service computer, where the wireless connection is established based on authentication information associated with a user of the mobile computer and input using an input module associated with the mobile computer;
means for presenting a service option, where the means for presenting is associated with the service computer; and
means for accepting a service selection, in response to the service option, from the user, where the means for accepting is compatible with the means for presenting, to thereby present the service selection to the user, using the means for presenting.

37. The system of claim 36 wherein the means for establishing the wireless connection comprises a means for establishing a Radio Frequency (RF) connection.

38. The system of claim 37 wherein the means for establishing the wireless connection comprises a means for establishing a Bluetooth wireless connection.

39. The system of claim 36 wherein the means for establishing the wireless connection comprises a means for establishing an infrared connection.

40. The system of claim 36 wherein the means for presenting comprises a display.

41. The system of claim 36 the means for presenting comprises-an Internet browser.

42. The system of claim 36 wherein the means for accepting comprises means for communicating with an inertial navigation system operable to detect a movement of the mobile computer.

43. A method for wireless, attributable access to computer-based services, by means of a mobile hand-held device, by a service user,
in which a service software runs on one or several networked service computers to provide a service by a service provider for potential service users temporarily located in a vicinity of a local service computer, and a service user located in the vicinity of the local service computer can wirelessly access the service software;
in which the mobile hand-held device is permanently in a possession of the service user or is temporarily assigned to the service user, and entries into the service software by the service user take place through a standard input/output of the mobile hand-held device; and
in which, for a purpose of data exchange, components of a service port on both the mobile hand-held device and the local service computer cooperate, using components for wireless communication, wherein those details whose attributability is to be secured are sent, provided with a digital signature, to a party desiring attributability or, in a case of a desire for attributability on a part of both parties, are countersigned by a recipient, if applicable, and returned.

44. The method of claim 43, characterized in that data, especially concerning an identity and a valid public key, are transmitted in the form of digital certificates, especially transmitted by the mobile hand-held device to the service computer as an application certificate for the service user and/or as a system certificate for the mobile hand-held device, wherein the certificates themselves are replaced by information on storage locations of these certificates, and transmitted by a service computer to the mobile hand-held device as a system certificate for the local service computer and/or as an application certificate for the service software and for the service,
wherein independently certified sub-components are contained in an application or system certificate of the invention in the form of several independent certificate, and each individual certificate is optional, and
the information to be authenticated on a case-by-case basis for the purpose of attributability is combined into a transaction data set which, if attributability is desired on the part of the service user, is authenticated by the service computer and transmitted to the mobile hand-held device and, if attributability is desired on the part of the service, and therefore the service software, is authenticated in the mobile hand-held device and transmitted to a desired extent.

45. The method of claim 44, characterized in that a mimic function is connected between the standard input/output of the mobile hand-held device and the service input of the service software, ahead of the service port on the mobile hand-held device, which maps input means in place in the mobile hand-held device onto the input means provided for the service software and expected by the service input.

46. The method of claim 45, characterized in that the mimic function in the mobile handheld device contains an inertial navigation system based on the mode of operation of an acceleration meter or a gyroscope, for recording the movement of the mobile hand-held device by the service user, and derives data therefrom for the service input, which are reproduced as pointer movements on a service output monitor.

47. The method of claim 46, wherein
the service software on the local service computer is featured as commercial Internet browser software and is supplemented with software whose interface to the Internet browser software is executed in standardized form as a plug-in, and
the service software is developed using software, document description and programming languages commonly found on the Internet, and
the service output of the service software occurs on a monitor visible to the service user and/or other channels perceptible to the service user, and
the portion of the service input for the service software not stored in advance is converted by the mobile hand-held device into matching data.

48. The method of claim 47, characterized in that data for recurring entries into the service software are stored in the mobile hand-held device, temporarily or permanently, as application certificates, system certificates, additional personal characteristics or service data, and
wherein such data for recurring entries is validated prior to use when using data or functions considered temporary from the perspective of the mobile hand-held device, or indispensable components of the data for recurring entries or other data or functions that are indispensable to validity and are not made available or are only made available for a brief period of validity in the mobile hand-held device,
wherein the data or functions considered temporary from the perspective of the mobile hand-held device or the components performing functions are made completely or partly accessible through reading devices or biometric sensors, or connections to other standard or embedded computers delivering these data or functions, unless they are to be entered through the standard input/output of the mobile hand-held device.

49. The method of claim 48 wherein the wireless connection between the mobile handheld device and the service computer contains the phases of greeting, negotiation and contract conclusion, wherein each of the consecutive phases of negotiation and contract conclusion represents a service use combined from the perspective of attributability, and multiple phases of service use can follow a greeting, and
the greeting phase begins with the discovery phase, which establishes an underlying wireless connection, which in turn is automatically initiated when the service user comes into proximity to a local service computer, overlapping with or followed by the security handshake phase, wherein options for the service use phases are negotiated,
wherein options relating to allowable service inputs are negotiated, as well as the mapping of the input means available in the mobile hand-held device onto the negotiated input means by a mimic function,
wherein, in the optional negotiation phase, details of service use are determined, in that recurring entries and/or data entered through the standard input/output are transmitted with the aid of the service port and the wireless connection, and are made accessible through the service input of the service software, possibly alternating with outputs at the service output, and
wherein, in the contract conclusion phase, the attributability of important communication contents is ensured by digital authentication and transmission of these contents and, if applicable and necessary, repeated digital authentication and return transmission,
wherein the service user must consent to the performance of attributable communication, in accordance with the provisions of valid laws, to a minimum extent, in that the service user performs entries through the standard input/output and, if applicable, the mimic function, and/or makes data or functions available through a reading device in a manner from which the consent of the service user to the performance of an attributable communication and subsequent service can derived,
wherein, upon arrival of a transaction data set authenticated and transmitted by the service software, it is displayed at the standard input/output of the mobile hand-held device to be checked by the service user, together with the request for confirmation of validity by the service user as a condition of the authentication and return transfer performed on his behalf.

50. The method of claim 49 wherein the wireless connection is executed as a local connection between the mobile hand-held device and local service computer, while using the standards of the Bluetooth™ SIG, or, alternatively, in accordance with other standards for wireless local communication.

51. The method of claim 50 wherein the wireless connection is executed as a connection through a public wireless network, wherein the service port can, in addition to being installed on the portable hand-held device and the local service computer, be distributed among other service computers, and the connection can also comprise wired segments.

52. A system for implementing a method for wireless, attributable access to computer-based services, by means of a mobile hand-held device, by a service user, comprising:
one or more networked service computers, on which a service software for the provision of a service by a service provider to potential service users temporarily located in the range of the local service computer runs, and on which a service user located in the range of the local service computer can wirelessly access the service software,
a mobile hand-held device, which is permanently in the possession of the service user or is temporarily assigned to said user and comprises a standard input/output and, optionally, a mimic component for conversion of entries made by the service user to correspond to the input means of the service software and reading devices and/or local memories, especially for an application certificate, a system certificate, personal characteristics, and/or service data, distributed cooperative components for service ports and wireless connections on a mobile hand-held device and selected service computers, through which data for more precisely determining the service use are transmitted from the mobile hand-held device to the local service computer and data relating to communication processes and attributability are exchanged.

53. The system of claim 52 wherein the local service computer is embedded in a device.
